(19) United States
(12) Patent Application Publication
(10) Pub. No.: US 2014/0027688 A1
(43) Pub. Date: Jan. 30, 2014

(54) Deconstruction Pry Bar

(71) Applicant: Lawrence C. Vesely, Fairview Park, OH (US)

(72) Inventor: Lawrence C. Vesely, Fairview Park, OH (US)

(21) Appl. No.: 13/917,577

(22) Filed: Jun. 13, 2013

Related U.S. Application Data
(60) Provisional application No. 61/659,380, filed on Jun. 13, 2012.

(51) Int. Cl. B66F 15/00

(52) U.S. Cl. CPC B66F 15/00
USPC 254/131.5; 254/131; 29/426.5

(57) ABSTRACT

Apparatus and method for prying up boards nailed to raised edges of support members, as in deconstruction of buildings, using a deconstruction pry bar having a relatively long shank extending upward from a fulcrum having a lateral axis, and a relatively short claw with at least one tang that extends downward from the fulcrum. Each tang is laterally offset relative to the fulcrum to enable a user to pry up boards by positioning the pry bar fulcrum for pivoting on top of the raised support member edge while the tang of the prying claw extends along a side of the support member, and then using lever action to convert a downward force on the shank to a greater upward force applied under the board by the claw tang.

### CROSS-REFERENCE TO RELATED APPLICATIONS

This application claims the benefit of U.S. Provisional Patent Application No. 61/659,380 filed Jun. 13, 2012 by Lawrence C. Vesely

### BACKGROUND OF THE INVENTION

Pry bars are well known. A widely used version is made of heavy steel strap metal, is straight or slightly bent on one end and curved to an L shape on the other. Each end has a claw-hammer-like V-shaped fork that creates a small gap in the middle of the leading edge for surrounding a nail shank. The gap is not large (maybe 0.25-0.5 inch) but does subtract from the wedging effect in the middle of the claw. To pry up a board nailed to a planar surface, the forked claw is pounded to wedge it under the board, then pulled with an applied force Fa to lever the bar on a fulcrum point either behind or at the tips of the two claw tangs (for L-shaped, or straight end respectively). This typical method of use (see FIGS. 1A side and 1B top views) tends to be destructive because the wedging action and the levering action both apply most or all of the prying force Fp at, or very close to, the leading edge corner of the board which is particularly vulnerable to splintering, and also the nail(s) holding the board down are generally located inward from the edge that is being pried, thereby providing a leveraged resistance force Fr that yields a resultant bending torque that can split the board along the longitudinal grain line at the nail.

Another problem is added when a board is nailed onto a relatively narrow edge of a support member (e.g., floorboard on floor joist as shown in FIGS. 1A-1B example), not onto a continuous planar surface. Examples include planks on rafters, joists, furring strips or wall studs. Since most of the “support” members (generically called “studs” hereinbelow) are no more than two inches wide, the pry bar has only a small surface area of contact between the forked pair of claw tangs (separated by the V-shaped gap) and the stud. This makes wedging-in more difficult to do without gouging the stud and/or board edge.

### BRIEF SUMMARY OF THE INVENTION

According to the invention a deconstruction pry bar for prying up boards nailed to raised edges of support members, as in deconstruction of buildings, comprises: an elongated shank, a prying claw extending therefrom, and a fulcrum positioned therebetween, wherein: the prying claw comprises at least one elongated tang that is laterally offset from the fulcrum.

According to an embodiment of the invention the deconstruction pry bar further comprises: a first tang and a second tang comprising the prying claw, wherein the first tang is laterally offset in a first direction from the fulcrum and the second tang is laterally offset in a second direction opposite to the first direction from the fulcrum.

Further according to the invention the first and second tangs are laterally spaced apart for straddling a support member of a predetermined edge width.

According to another embodiment of the invention the fulcrum is shaped and positioned for pivoting on top of the raised support member edge while the at least one tang of the prying claw extends along a side of the support member.

According to the invention the deconstruction pry bar further comprises a tang extension that extends generally downward between the fulcrum and the at least one tang, wherein the at least one tang extends generally forward.

Further according to the invention the at least one tang is adapted to extend generally forward a distance sufficient for positioning the at least one tang under the board at a selected insertion depth.

According to the invention the deconstruction pry bar further comprises a tip at a forward end of the at least one tang, wherein the tip is shaped to spread out an area of the board where prying force is applied by the deconstruction pry bar.

According to the invention a method for prying up boards nailed to raised edges of support members, as in deconstruction of buildings, comprises the steps of: providing a pry bar comprising an elongated lever with a relatively long shank extending upward from a fulcrum having a lateral axis, and a relatively short claw comprising a tang extending downward from the fulcrum; laterally offsetting the tang relative to the fulcrum; and prying up boards by: positioning the pry bar fulcrum for pivoting on top of the raised support member edge while the tang of the prying claw extends along a side of the support member, and using lever action to convert a downward force on the shank to a greater upward force applied under the board by the claw tang.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different versions of an element 109 which are similar or related in some way but are separately referenced for the purpose of describing modifications to the parent element (109). Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIGS. 1A-1B are side and top plan views, respectively, of a prior art pry bar being used to pry up a board nailed to a floor joist example of a support member.

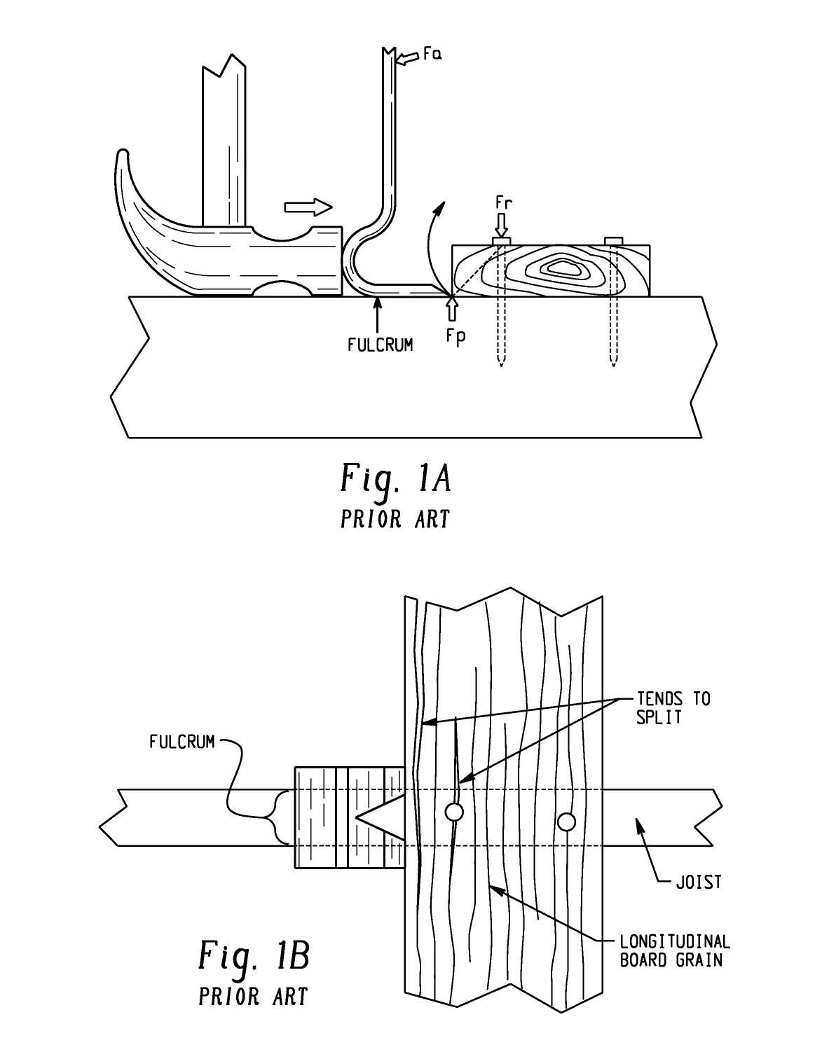

FIGS. 2A-2B are side and top plan views, respectively, of a deconstruction pry bar and method of use, according to the invention.

FIGS. 3-4 are perspective and side views, respectively, of a deconstruction pry bar and method of use, according to the invention.

FIG. 5 is a perspective view of a deconstruction pry bar according to the invention.

FIGS. 6A-7B illustrate aspects of example embodiments of a deconstruction pry bar according to the invention, all being shown in a position of use; wherein FIG. 6A is a side view of deconstruction pry bar embodiments 100a to 100e; FIG. 6B is a perspective view of the embodiment 100e; and FIGS. 7A-7B are top plan and side views, respectively, of a deconstruction pry bar embodiment 100f and a method of use, all according to the invention.

### DETAILED DESCRIPTION OF THE INVENTION

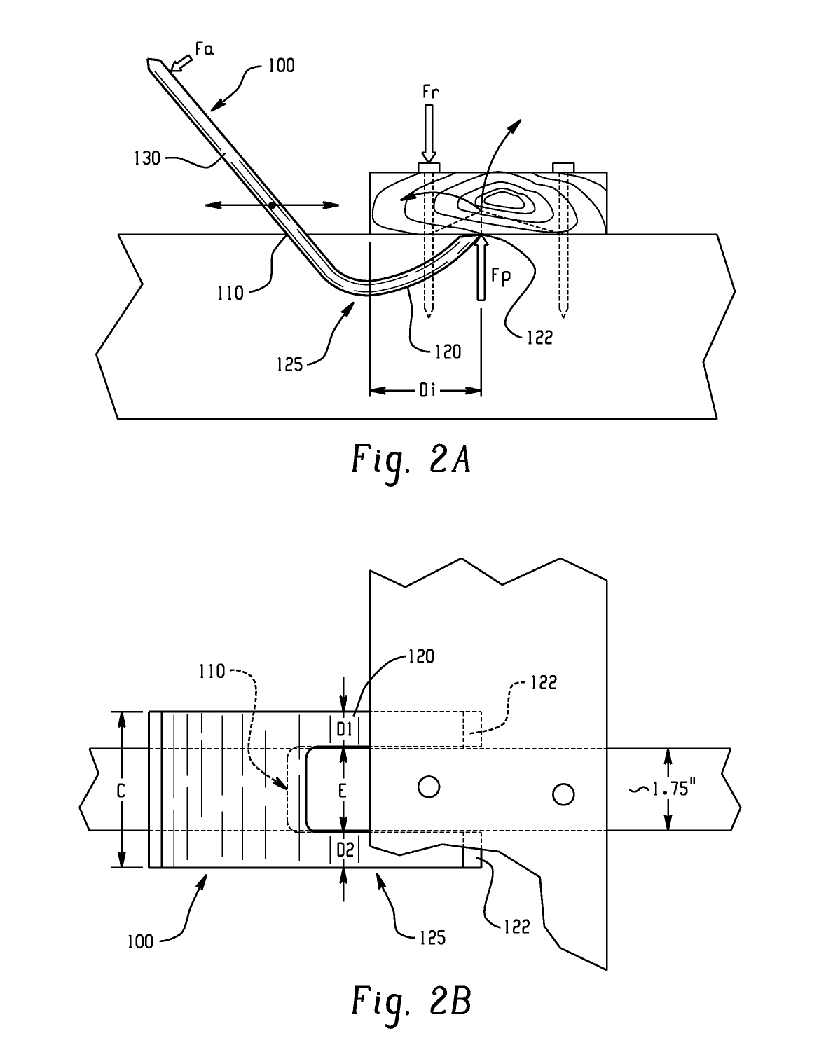

FIGS. 2A-2B illustrate an example of the novel, improved method of use that is enabled by the new shape and dimensions of the hereindisclosed deconstruction pry bar 100, described in detail further below. Because of the novel claw 125 design, a spacing E (e.g., 2 inches for use with floorboards across 1.75″ edge-width floor joists) between tangs 120 of the claw 125, and a laterally-straight (e.g., squared-off) inside edge 110, the fulcrum for prying becomes the edge 110 which is laterally offset from the tang(s) 120 of the claw 125 such that the tang 120 can be positioned beside the stud upon which the fulcrum 110 rests. Preferably the claw/tang is shaped such that the tang end (tip) 122 is positionable for application of upward prying force Fp to the underside of the board at a selectable insertion depth Di measured inward from the leading edge of the board to be pried. Thus the tangs 120 can be effortlessly positioned under the board at a selectable location across the width of the board. For example, the tang tip 122 can be located directly below a nail to minimize board splitting. The claw 120 may be advantageously shaped (e.g., curved) such that when force Fa is applied to the shank/handle 130, the leveraged prying force Fp is directed substantially vertically, i.e., in line with the nail to optimize nail pulling efficacy. Or the insertion depth Di can be selected to position the tip 122 between the nails in a way that optimizes the amount of torque around the resisting forces Fr of the nails.

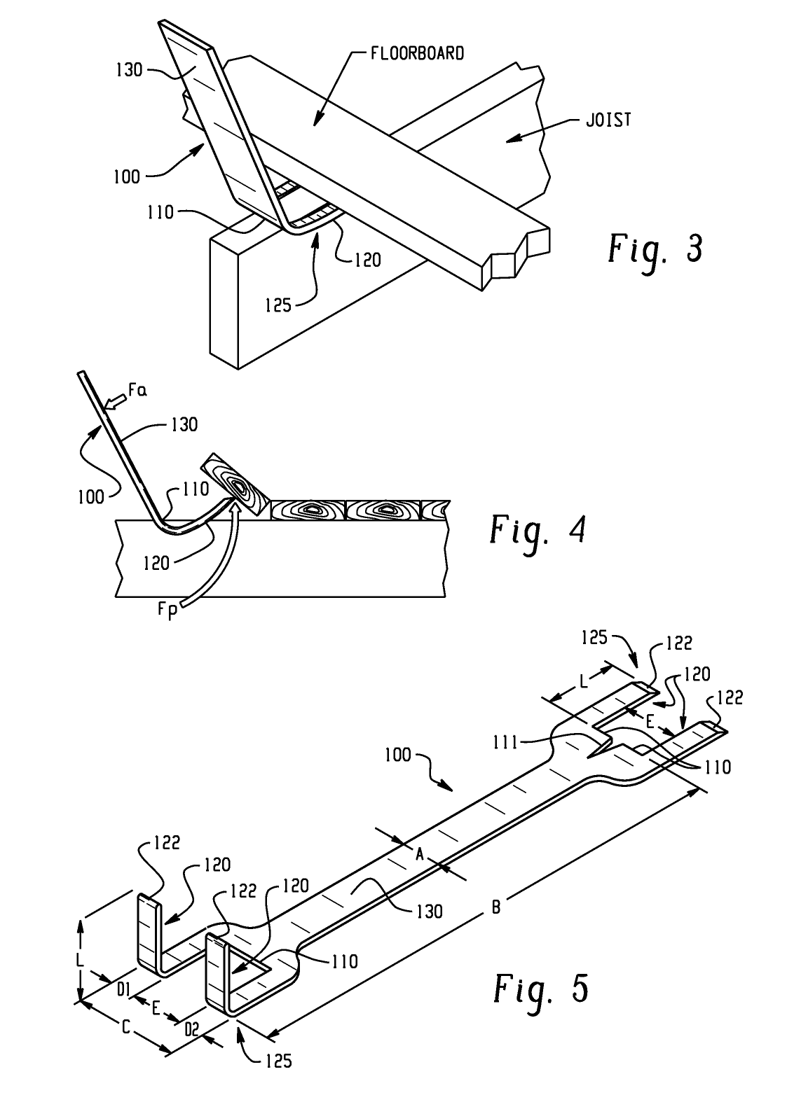

Referring now to FIGS. 3-5, representative embodiments of the inventive offset pry bar 100 are described. Specific dimensions disclosed are not limiting unless stated otherwise. The deconstruction pry bar 100 may be formed from a unitary body of, for example, ¼ inch steel strap or bar (i.e., ribbon shaped) material, hardened, annealed, forged, etc. according to conventional pry bar manufacturing methods. The pry bar 100 has a relatively long shank 130 that produces a lever arm length B (e.g., 18″ from fulcrum 110 to opposite end of pry bar) that is suitable for obtaining a desirable amount of leverage when combined with a relatively short prying arm length (e.g., the tang length L extending from the fulcrum 110). The shank is width A (e.g., 2″) according to strength criteria and convenience for holding by the user.

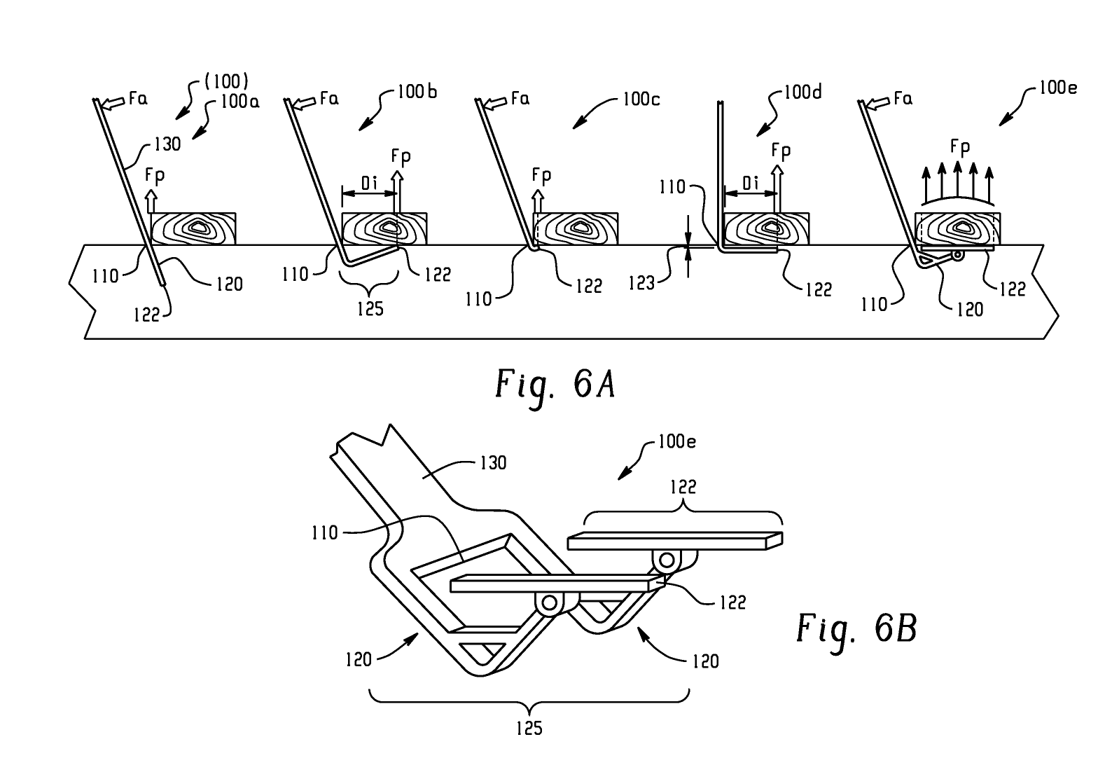

At least one end of the bar has a form of the inventive claw 125. In the FIG. 5 embodiment, an L-shaped type of claw 125 is shown on one end, and a nominally straight type of claw 125 on the other end, both being shown with a two-tang straddling claw (straddled about the fulcrum 110). In other words, the two-tang straddling claw has one tang 120 laterally offset in one direction from the fulcrum 110 and the other tang 120 laterally offset in the opposite direction from the fulcrum 110. The straight straddling claw 125 is shown with an optional nail-pulling fork 111 added. The claw width C (e.g., 4″) is the sum of the tang width(s) D (D1 and D2) (e.g., 1″) plus the fulcrum edge width E (e.g., 2″). The tang length L (e.g., 3″), and also tang width D and fulcrum width E, may be determined by the type of use anticipated and/or the shape of the claw and tang 120. Type of use includes considering width of the stud, width of boards on the studs, softness of the wood, tendency to split, nail resistance force, nail spacing, and the like.

The tang end tip 122 can be provided with a variety of shapes, for example: rounded (as shown on the L-shaped claw 125), chisel (as shown on the straight claw 125), square, rubber coated (softened), etc. Likewise, the fulcrum edge may be given a shape according to its anticipated use (e.g., rounded, or softened to minimize indentation of the stud).

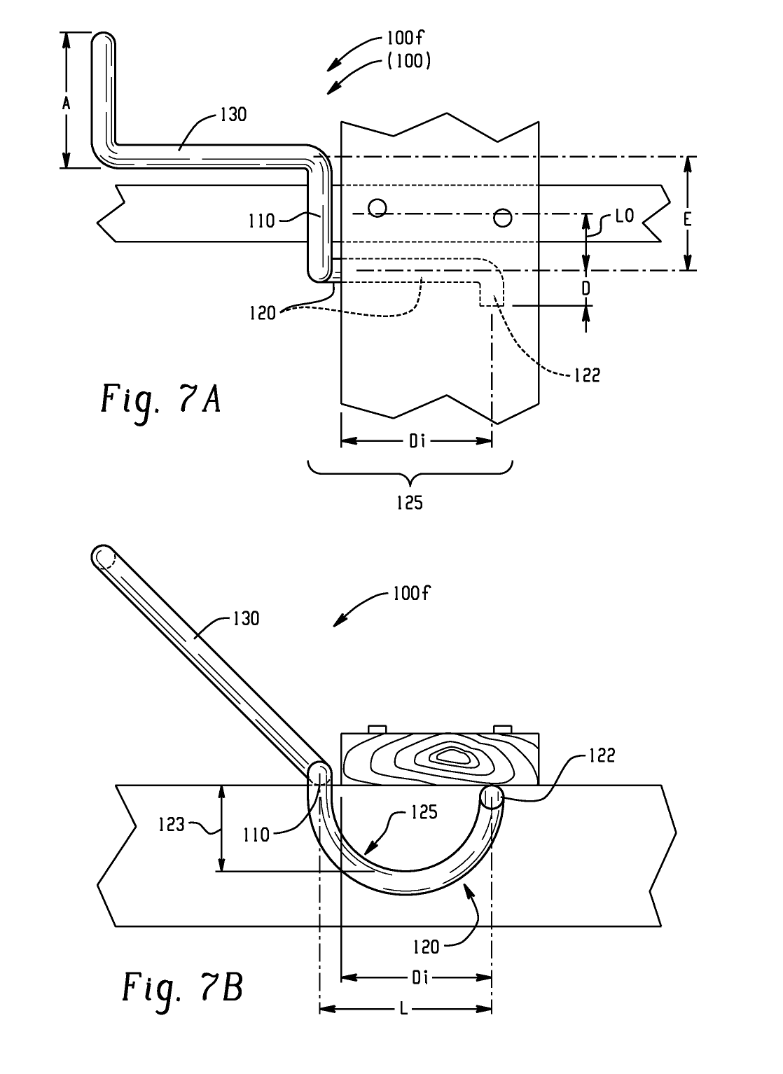

The claw 125 may have one or two offset tangs 120 to form a single-tang or a straddling type of claw 125, respectively. FIGS. 6A-7B show some examples of offset pry bar 100 embodiments. For example, the tang(s) 120 can be straight (bar 100a); a sharp L bend (100b, 100d), straight with a bump or second elbow at end (100c), a gradual curve such as a 180 degree arc (100f), a braced structure (100e), etc., and preferably includes an extension 123 where the tang 120 joins the fulcrum edge 110 for the purpose of lowering the tang 120 below the fulcrum 110, thereby avoiding contact with the leading edge of the board on the stud (e.g., 100b, 100d, 100e and 100f). It can be seen that the tang 120 and tang tip 122 may be shaped and dimensioned to meet various design objectives, such as moving the point of prying force Fp application and/or spreading out the application area for the prying force Fp.

As shown in the two views of embodiment 100e, the tang tip 122 may be quite elaborate, such as, for example, a long flat plate pivotingly connected to the tang 120.

In the embodiment 100f illustrated in top and side views of FIGS. 7A and 7B, a single-tang offset pry bar 100 is formed from a single length of round rod stock. In addition to the tang 120 being laterally offset from the fulcrum, enhancements include: a claw 125 that includes a straight downward tang extension 123 followed by a 180 degree curved tang 120 for making the prying force Fp substantially vertical in direction; a relatively long tang L for optimum positioning against the board bottom at a selected insertion depth Di; using a bend in the rod to enlarge the effective tang tip width D; a rounded tip 122, a rounded fulcrum 110 of sufficient width E, and a handle laterally extending the shank 130 to a width A convenient for holding and hand applying levering force Fa. Also, the shank and handle are offset to the opposite side of the fulcrum relative to the tang and tip. This helps balance lateral force vectors that would otherwise cause torque around the fulcrum tending to tip the shank toward the tang side of the fulcrum in reaction to the resistance force Fr on the single tang 120.

Although the invention has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of invention(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

What is claimed is:

1. A deconstruction pry bar for prying up boards nailed to raised edges of support members, as in deconstruction of buildings, comprising:
an elongated shank, a prying claw extending therefrom, and a fulcrum positioned therebetween, wherein:
the prying claw comprises at least one elongated tang that is laterally offset from the fulcrum.

2. The deconstruction pry bar of claim 1, further comprising:
a first tang and a second tang comprising the prying claw, wherein the first tang is laterally offset in a first direction from the fulcrum and the second tang is laterally offset in a second direction opposite to the first direction from the fulcrum.

3. The deconstruction pry bar of claim 2, further wherein:
the first and second tangs are laterally spaced apart for straddling a support member of a predetermined edge width.

4. The deconstruction pry bar of claim 1, further wherein:
the fulcrum is shaped and positioned for pivoting on top of the raised support member edge while the at least one tang of the prying claw extends along a side of the support member.

5. The deconstruction pry bar of claim 1, further comprising:
a tang extension that extends generally downward between the fulcrum and the at least one tang, wherein the at least one tang extends generally forward.

6. The deconstruction pry bar of claim 1, further wherein:
the at least one tang is adapted to extend generally forward a distance sufficient for positioning the at least one tang under the board at a selected insertion depth.

7. The deconstruction pry bar of claim 1, further comprising:
a tip at a forward end of the at least one tang, wherein the tip is shaped to spread out an area of the board where prying force is applied by the deconstruction pry bar.

8. A method for prying up boards nailed to raised edges of support members, as in deconstruction of buildings, the method comprising the steps of:
providing a pry bar comprising an elongated lever with a relatively long shank extending upward from a fulcrum having a lateral axis, and a relatively short claw comprising a tang extending downward from the fulcrum;
laterally offsetting the tang relative to the fulcrum; and
prying up boards by:
positioning the pry bar fulcrum for pivoting on top of the raised support member edge while the tang of the prying claw extends along a side of the support member; and
using lever action to convert a downward force on the shank to a greater upward force applied under the board by the claw tang.
